(19) United States
(12) Patent Application Publication
(10) Pub. No.: US 2018/0018659 A1
(43) Pub. Date: Jan. 18, 2018

(54) SYSTEM AND METHOD FOR REMOTE AGE VERIFICATION FOR DELIVERY TRANSACTIONS

(71) Applicant: Robert Bolton, Aurora, IL (US)

(72) Inventor: Robert Bolton, Aurora, IL (US)

(21) Appl. No.: 15/207,582

(22) Filed: Jul. 12, 2016

(51) Int. Cl. G06Q 20/38; G06Q 20/36

(52) U.S. Cl. CPC G06Q 20/3821; G06Q 20/3674

(57) ABSTRACT

A remote age verification system and method for ensuring the recipient of a delivery of age restricted items, such as alcoholic beverages, is of the appropriate age and has the requisite funds is implemented through a verifying software application loaded on mobile device which employs an account setup method and an age and funds verification method. The account set up method operates to confirm a user's eligibility to place orders for the delivery of age restricted items and includes the steps of extracting and saving identification data, extracting and saving credit card data, ensuring identification and credit card information are valid and match, and activating an account. The age and funds verification method operates to facilitate the ordering and delivery of age restricted items in a way that minimizes ensures a purchaser is old enough and has the funds to make the order.

### BACKGROUND OF THE INVENTION

### Field of the Invention

This invention relates generally to remote verification systems and, more particularly, to a system and method for remote identification verification in a product delivery procurement software application.

### Description of the Prior Art

The use of communication devices to arrange for the delivery of selected items is well established. Indeed delivery of items such as food from local merchants of through local services is common in many areas. A problem which still exists, however, is that arranging for the delivery of items whose purchase and/or consumption requires age verification can be very cumbersome due to the limitations in reliably authenticating a purchaser's age remotely. Thus, there remains a need for a remote age verification system and method which would allow for a purchaser's identity and age to be confirmed for a delivery transaction. It would be helpful if such a remote age verification system and method operated to verify a purchaser's age prior to a transaction being initiated and the purchaser's identity upon delivery of purchased items. It would be additionally desirable for such a remote age verification system and method to require a geolocation confirmed acknowledgment at the time of delivery of a purchased item to ensure the purchaser is the actual recipient upon item delivery.

The Applicant's invention described herein provides for a remote age verification system and method adapted to allow for a user authentication and age verification process designed to both ensure a purchaser's eligibility to purchase items prior to confirming a transaction and confirm the purchaser's authenticity at the time of delivery. The primary components in Applicant's rotating broom apparatus are a handle, wheels, gears, and bristles. When in operation, the remote age verification system and method enables more effective and efficient arranging of delivery for age restricted items. As a result, many of the limitations imposed by prior art structures are removed.

### SUMMARY OF THE INVENTION

A remote age verification system and method for ensuring the recipient of a delivery of age restricted items, such as alcoholic beverages, is of the appropriate age and has the requisite funds. The remote age verification system and method is implemented through a verifying software application loaded on mobile device which employs an account setup method and an order validation method. The account set up method operates to confirm a user's eligibility to place orders for the delivery of age restricted items and includes the steps of extracting and saving identification data, extracting and saving credit card data, ensuring identification and credit card information are valid and match, and activating an account. The age and funds verification method operates to facilitate the ordering and delivery of age restricted items in a way that minimizes ensures a purchaser is old enough and has the funds to make the order.

It is an object of this invention to provide a remote age verification system and method which would allow for a purchaser's identity and age to be confirmed for a delivery transaction.

It is another object of this invention to provide a remote age verification system and method operative to verify a purchaser's age prior to a transaction being initiated and enable the purchaser's identity upon delivery of purchased items.

It is yet another object of this invention to provide a remote age verification system and method which requires a geolocation confirmed acknowledgment at the time of delivery of a purchased item to ensure the purchaser is the actual recipient upon item delivery.

These and other objects will be apparent to one of skill in the art.

### BRIEF DESCRIPTION OF THE DRAWINGS

FIG. 1 shows the operative components of a remote age verification system in accordance with the present invention.

FIG. 2 shows the steps through which a remote age verification system in accordance with the present invention creates a purchaser account.

FIG. 3 shows the steps through which a remote age verification system in accordance with the present invention validates a delivery order.

### DETAILED DESCRIPTION OF THE INVENTION

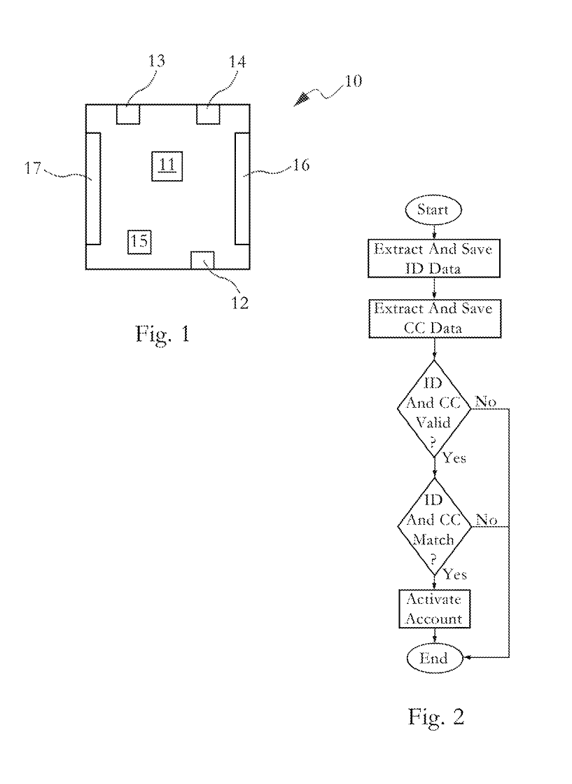

Referring now to the drawings and in particular FIG. 1, a remote age verification system is implemented through a verifying software application loaded on mobile computer 10 (or “mobile device”), such as a smart phone or tablet, with the software application containing instructions which cause a processor 11 on the mobile computer 10 to perform the steps of the age verification method detailed below. It is contemplated that a mobile computer 10 operative to implement the remote age verification system would additionally include at least an image capture device 12, such as a camera, a networking interface 13, a positioning interface 14, such as a GPS receiver, a data storage medium 15, such as computer memory, a user input interface 16, and a display interface 17, each whose operation may be controlled by the processor 11.

Referring now to FIG. 2, an account setup method in accordance with the present invention is generally a prerequisite for using the age verification method to arrange for delivery of age restricted items. In one embodiment, each unique purchaser account is associated with a single corresponding mobile device. As such, a purchaser desiring to create an account would first user the mobile device and capture an identification image of a photo identification card, such as a drivers license, with the image capture device. The age verification system then extracts and saves as identification data the purchaser's name, address, date of birth, and expiration date from the identification image using an optical character recognition software module. In some embodiments, the purchaser's driver's license number is also extracted and save as identification data. It is contemplated that the identification data is saved on the data storage medium as under a purchaser profile.

Once the identification data is saved, the purchaser captures an image of a credit card (or debit card) owned by the purchaser. The age verification system then extracts and saves as credit card data the credit card name, credit card number and expiration date from the credit card image using the optical character recognition software module. In some embodiments, the age verification system is required to be entered, either manually or through an image, and is then saved as credit card data. It is contemplated that the credit card data is saved on the data storage medium as under the purchaser profile.

Once the identification data and credit card data are saved, the age verification system verifies that the names in the identification data and credit card data match and the that neither the identification card or credit card has expired. If the names match, age verification system accesses over the networking interface the Address Verification System and verifies that the address in the identification data matches the address on file at the credit card company. If the addresses match, the age of the purchaser is calculated from the date of birth in identification data and the purchaser account is activated.

In one embodiment, the verifying software application includes a directory of ecommerce portals for merchants (and/or delivery services) who allow the purchase of and facilitate the delivery of age restricted items, such as alcoholic beverages. It is contemplated, however, that such a directory and portals are only accessible to purchaser's having an activated purchaser account and whose age exceeds the legal age of purchase for such a age restricted item. It is additionally contemplated that the portals may be sorted in the directory by a user's physical location as determined by the positioning interface on the mobile device associated with the purchaser account. Accordingly, a purchaser having an activated purchaser account may use the verifying software application to enter into a electronic transaction with a merchant/service who will deliver age restricted items to the purchaser's present location through the merchant's portal in order to arrange for delivery of selected age restricted items

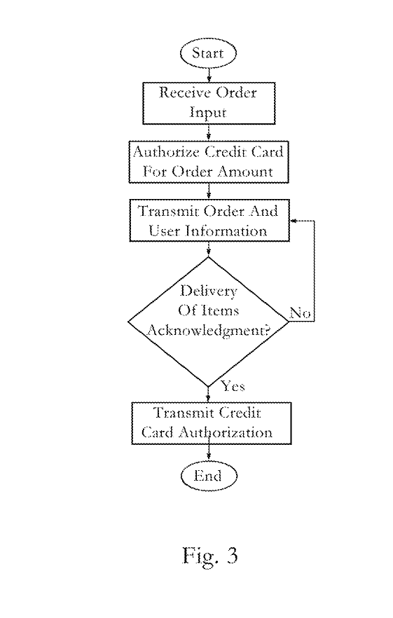

Referring now to FIG. 3, when a purchaser with an activated purchaser account desires to arrange for delivery of selected age restricted items the verifying software application must execute a order validation method to ensure the purchaser is of age and has the funds to complete the order. In the order validation method, the purchaser would first use the ecommerce portal of a merchant to place an order for the delivery of the selected age restricted items. Because the purchaser's age and identity have already been verified and the purchaser's payment information has been confirmed by the age verification system at the account setup step, the merchant may act to fulfill the order with the confidence that the purchaser is of age and has the funds to pay for the order. Once an order is placed, the age verification system authorizes the purchaser's credit card for the total cost of the order (including any taxes and fees), transmits the order, the name, age, and photograph of purchaser, and the present location of the purchaser to the selected merchant so the merchant can gather and deliver the selected items to the purchaser's present location. Finally, upon the delivery of the selected items to the purchaser's location, the purchaser acknowledges the delivered items through an acknowledgment interface generated by the verifying software application and, once each item is acknowledged, the age verification system finalizes the credit card payment by transmitting the credit card authorization information (including an approval code) over the networking interface to the merchant.

It is contemplated that because a merchant is transmitted a image of the purchaser (along with the name and age), the merchant may identify the correct purchaser on sight (a merchant may at their option additionally verify the purchasers identification card manually). It is further contemplated that a merchant may want to verify that a user acknowledges a transaction prior to transferring possession of the delivered items.

It is appreciated that the verifying software application is operative to minimize how much of a user's information must be transmitted to external devices, including any remote server operating in conjunction with the verifying software application to process payment transactions.

In some embodiments, the verifying software application may access government records to confirm the authenticity of identification data during the account setup process.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A remote age verification system for arranging for delivery of age restricted items, comprising:
a mobile computer having a processor, an image capture device, a networking interface, a positioning interface, at least one data storage medium, and a user input interface, wherein said mobile computer is configured to setup a purchaser account and validate a delivery order;
wherein the setup of a purchaser account includes capturing as an identification image an image of a photo identification card for a first purchaser, extracting identification data defining at least a name, address, date of birth, and expiration date from the identification image, and saving the extracted identification data to a first purchaser account profile;
wherein the setup of a purchaser account additionally includes capturing as a credit card image an image of a credit card belonging to the first purchaser, extracting credit card data defining at least a card name, card number and card expiration date from the credit card image, and saving the extracted credit card data; and
wherein the setup of a purchaser account additionally includes comparing the address from the saved identification data to an address on file with the issuer of the credit card credit card belonging to the first purchaser and calculating the age of the first purchaser.

2. The remote age verification system of claim 1, wherein the setup of a purchaser account additionally includes comparing the name from the saved identification data to the card name from the saved credit card data.

3. The remote age verification system of claim 2, wherein the validation of a delivery order includes:
receiving an order input which specifies at least items to be delivered, a total cost, a fulfilling merchant, and a real time location of the mobile computer as determined by the positioning interface;
authorizing the credit card belonging to the first purchaser using saved credit card data for at least the total cost; and
causing data related to the order input to be transmitted to the fulfilling merchant.

4. The remote age verification system of claim 3, wherein the validation of a delivery order additionally includes causing data related to the credit card authorization to the fulfilling merchant.

5. The remote age verification system of claim 4, wherein data related to the credit card authorization to the fulfilling merchant is only transmitted upon delivery of items to be delivered to the real time location of the mobile computer.

6. The remote age verification system of claim 1, wherein the validation of a delivery order includes:
receiving an order input which specifies at least items to be delivered, a total cost, a fulfilling merchant, and a real time location of the mobile computer as determined by the positioning interface;
authorizing the credit card belonging to the first purchaser using saved credit card data for at least the total cost; and
causing data related to the order input to be transmitted to the fulfilling merchant.

7. The remote age verification system of claim 6, wherein the validation of a delivery order additionally includes causing data related to the credit card authorization to the fulfilling merchant.

8. The remote age verification system of claim 7, wherein data related to the credit card authorization to the fulfilling merchant is only transmitted upon delivery of items to be delivered to the real time location of the mobile computer.
